(19) United States
(12) Patent Application Publication
(10) Pub. No.: US 2003/0122043 A1
(43) Pub. Date: Jul. 3, 2003

(54) Tilting preventing foot rest for suitcase or the like

(76) Inventor: Tung Lung Wang, Taichung Hsien (TW)

Correspondence Address: CHARLES E. BAXLEY, 59 John Street-5th Floor, New York, NY, 10038, US

(21) Appl. No.: 10/026,030

(22) Filed: Dec. 27, 2001

(51) Int. Cl. F16M 11/20; A47B 91/00

(52) U.S. Cl. 248/188.8

(57) ABSTRACT

A foot rest for attaching to a bottom portion of an object, such as a suitcase, includes a front portion extended forward and downward from an upper portion toward a lower portion for forming an inclined surface in the front portion of the foot rest and for forming a stable supporting structure to the suitcase and for preventing the suitcase from tilting forward and falling down. The inclined surface is preferably concave. The foot rest includes a groove formed in the front and bottom portion for forming a forward extending flange in the front and bottom portion.

### BACKGROUND OF THE INVENTION

1. Field of the Invention

The present invention relates to a foot rest, and more particularly to a foot rest for attaching to the suitcases or the like, and for preventing the suitcases from being tilted forward or from falling down.

2. Description of the Prior Art

Typical suitcases or the like comprise a rear portion having one or more wheels for allowing the suitcases to be moved, and a front portion having one or more pads attached to the bottom thereof. The pads may not be used for preventing the suitcases from being tilted or from falling down. Normally, one or more pads are further attached to the middle of the bottom portion of the suitcases, for stably supporting the suitcases in place, but also may not be used for preventing the suitcases from being tilted or from falling down.

The present invention has arisen to mitigate and/or obviate the afore-described disadvantages of the conventional foot rests for suitcases or the like.

### SUMMARY OF THE INVENTION

The primary objective of the present invention is to provide a foot rest for attaching to the suitcases or the like, and for preventing the suitcases from being tilted or from falling down.

In accordance with one aspect of the invention, there is provided a foot rest for attaching to a bottom portion of an object, such as a suitcase or the like, the foot rest comprising a foot rest body including an upper portion for attaching to the bottom portion of the object, and including a lower portion, and including a front portion extended forward and downward from the upper portion thereof toward the lower portion thereof, for forming an inclined surface in the front portion thereof and for forming a stable supporting structure to the suitcase and for preventing the suitcase from tilting forward and downward and for preventing the suitcase from falling down.

The inclined surface of the foot rest body is preferably concave. The foot rest body includes a front and bottom portion having a groove formed therein for forming a forward extending flange on the front and bottom portion thereof.

The foot rest body includes two sides each having a curved surface formed therein, for such as the decorative purposes. The foot rest body includes an orifice formed therein for weight reducing purposes or the like.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a plan view illustrating a suitcase having a foot rest in accordance with the present invention;

FIG. 2 is an enlarged partial perspective view showing the attachment of the foot rest to the bottom of the suitcase;

FIG. 3 is a perspective view of the foot rest;

FIG. 4 is a perspective view similar to FIG. 3, illustrating the other embodiment of the foot rest;

FIG. 5 is an enlarged partial perspective view similar to FIG. 2, illustrating the attachment of the foot rest as shown in FIG. 4 to the bottom of the suitcase; and

FIG. 6 is a plan view similar to FIG. 1, illustrating the operation of the foot rest for the suitcase.

### DETAILED DESCRIPTION OF THE PREFERRED EMBODIMENT

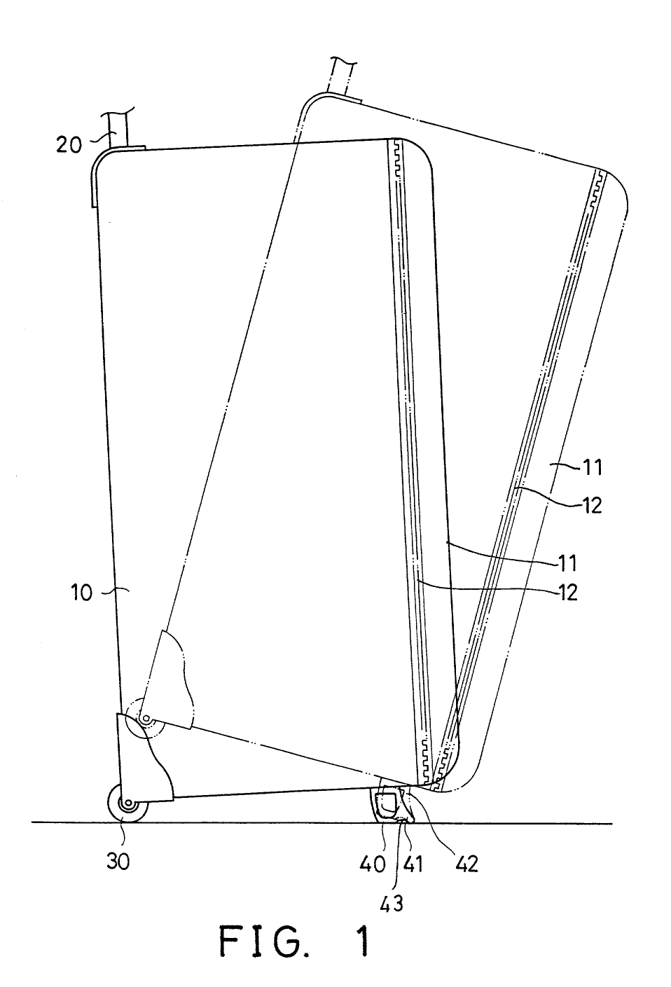

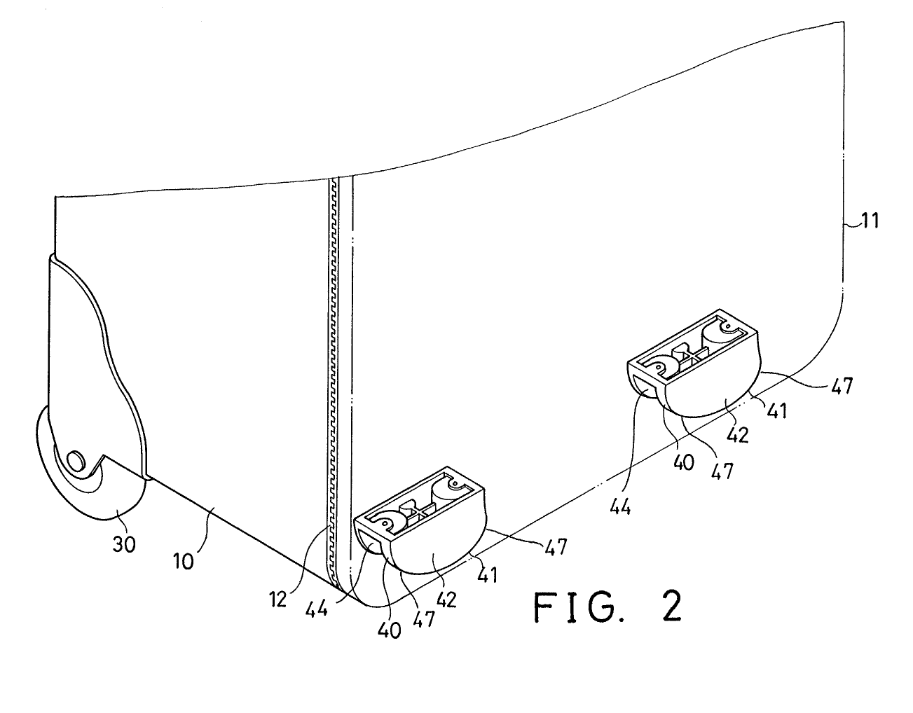

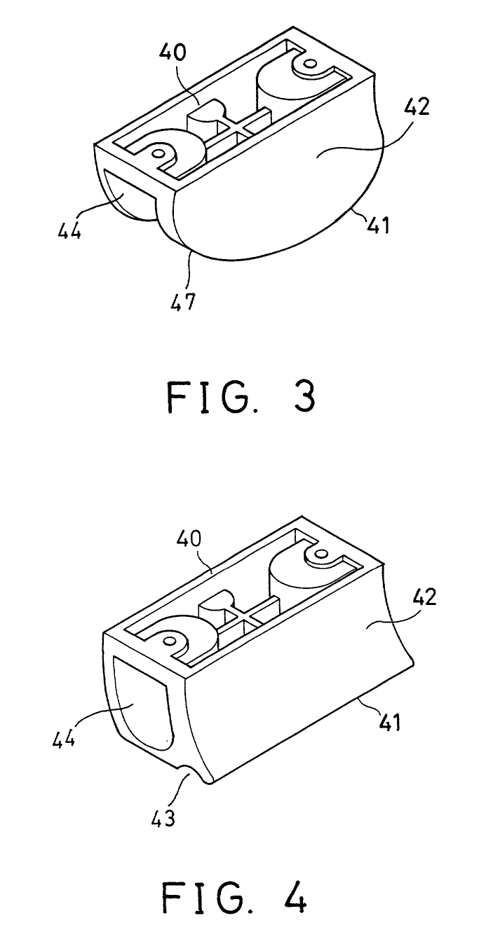

Referring to the drawings, and initially to FIGS. 1-3, a foot rest 40 in accordance with the present invention is provided for attaching to the bottom of various kinds of objects, such as the suitcases or the like, and for preventing the suitcases from being tilted or from falling down. The object, such as the suitcase 10 comprises a handle device 20, such as a retractable handle device 20 attached to the rear and upper portion thereof, a wheel device 30 having one or more wheel members 30 attached to the rear and lower portion thereof, for allowing the suitcase 10 to be tilted and moved or carried with the handle device 20.

The foot rest 40 is provided for attaching to the front and bottom portion of the suitcase 10 and includes a foot rest body 40 having an upper portion secured to the front and bottom portion of the suitcase 10 with fasteners or the like, and having a concave and inclined surface 42 formed in the front portion thereof. The surface 42 is inclined from the upper portion of the foot rest body 40 downward and forward toward the lower and front portion of the foot rest body 40, such that the foot rest body 40 includes a forward extending lower and front portion. The foot rest body 40 includes a groove 43 formed in the lower and front portion thereof for forming a flange 41 in the front and lower portion thereof and for forming a stable supporting structure.

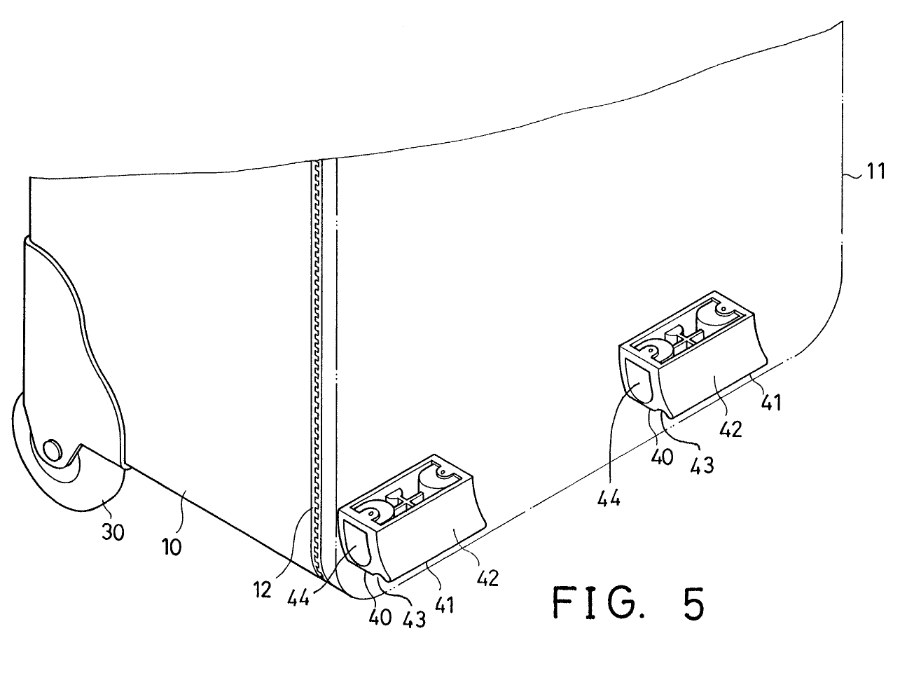

The foot rest body 40 includes an orifice 44 formed therein for weight reducing purposes or the like, and includes two rounded or curved surfaces 47 formed in the lower and side portions thereof, for such as the decorative purposes. Alternatively, as shown in FIGS. 4 and 5, the foot rest body 40 may include a rectangular shape as seen from the front portion thereof, without forming the rounded or curved surfaces 47 formed in the lower and side portions thereof.

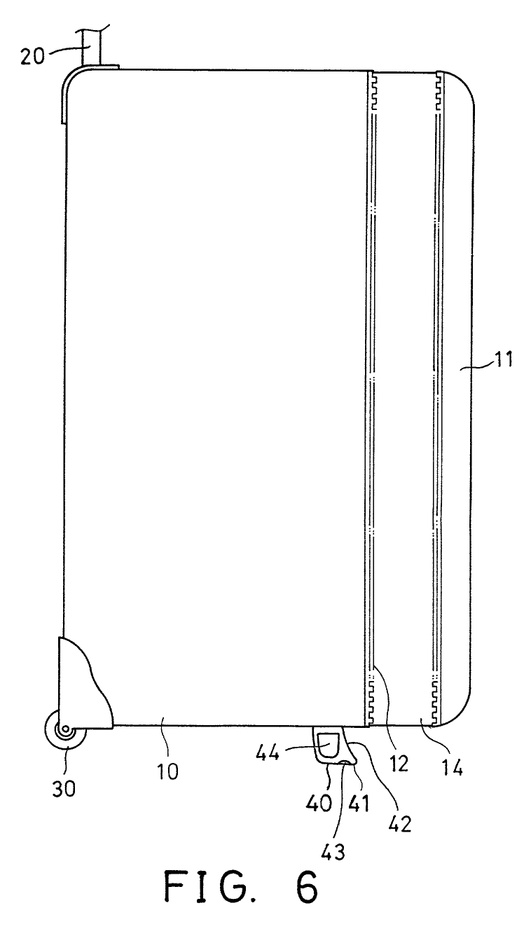

In operation, as shown in FIG. 1, the forward extending flange 41 that is formed in the front and lower portion of the foot rest body 40 may form a stable structure for the foot rest body 40 and thus for the object or the suitcase 10, and for preventing the suitcase 10 from tilting forward and downward. As shown in FIG. 6, a cover 11 is secured to the suitcase 10 with a zipper 12 or the like and may be moved away from the suitcase 10 for forming a compartment 14 when the zipper 12 is opened, as shown in dotted lines in FIG. 6. The foot rests body 40 may also provide a stable structure for the suitcase 10 to prevent the suitcase 10 from being tilted forward and downward.

Accordingly, the foot rest in accordance with the present invention may be provided for attaching to the suitcases or the like, and for preventing the suitcases from being tilted or from falling down.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A foot rest for attaching to a bottom portion of an object, said foot rest comprising:
a foot rest body including an upper portion for attaching to the bottom portion of the object, and including a lower portion, and including a front portion extended forward and downward from said upper portion thereof toward said lower portion thereof, for forming an inclined surface in said front portion thereof and for forming a stable supporting structure.

2. The foot rest according to claim 1, wherein said inclined surface of said foot rest body is concave.

3. The foot rest according to claim 1, wherein said foot rest body includes a front and bottom portion having a groove formed therein for forming a forward extending flange on said front and bottom portion thereof.

4. The foot rest according to claim 1, wherein said foot rest body includes two sides each having a curved surface formed therein.

5. The foot rest according to claim 1, wherein said foot rest body includes an orifice formed therein for weight reducing purposes.
